(19) United States
(12) Patent Application Publication
(10) Pub. No.: US 2014/0242216 A1
(43) Pub. Date: Aug. 28, 2014

(54) Amino Acid And Protein Hydrolysate Based Formulas With A Stable Emulsion System

(71) Applicant: Mead Johnson Nutrition Company, (US)

(72) Inventors: Zihua Ao, Newburgh, IN (US); John D. Alvey, Evansville, IN (US); Juan M. Gonzalez, Newburgh, IN (US); Jennifer Villegas, Evansville, IN (US)

(73) Assignee: Mead Johnson Nutrition Company, Glenview, IL (US)

(21) Appl. No.: 13/775,202

(22) Filed: Feb. 24, 2013

(51) Int. Cl. A23L 1/29

(52) U.S. Cl. CPC A23L 1/296
USPC 426/61; 426/648; 426/71; 426/590

(57) ABSTRACT

The present disclosure relates in part to an emulsion system comprising a waxy starch. The emulsion system is useful, in some embodiments, for incorporation into infant formulas comprising protein equivalent sources, such as formulas designed for individuals with certain protein allergies. Thus, in certain embodiments, the present disclosure relates to a nutritional composition comprising a protein equivalent source comprising a hydrolyzed protein, amino acids, or a mixture thereof, a fat source, a carbohydrate source, and an emulsifier system comprising a waxy starch. The emulsifier system may further include citric acid esters of mono- and di-glycerides or an octenyl succinic acid-modified starch, or both.

### TECHNICAL FIELD

The present disclosure relates to nutritional compositions comprising an emulsion system comprising a waxy starch or a waxy starch and citric acid esters of mono- and di-glycerides.

### BACKGROUND

Emulsifiers are often used in nutritional compositions, such as infant formulas, to provide homogeneity and prevent undesirable properties. However, the effectiveness of emulsion systems is affected by the nature and amount of the emulsifier, as well as the nature of the other components in the nutritional composition, such as the source of lipid, carbohydrate, and protein, as well the presence of salt and stabilizers. Unstable emulsion during processing of powdered formulas may cause unacceptable properties in the finished product, such as phase separation, lipid oxidation, nutrient degradation, and lumping. Additionally, poor emulsion properties in the reconstituted product can result in creaming, which is an undesirable property in infant formulas, and creates particular difficulties and concerns during tube feeding.

In particular, it can be difficult to provide a suitable emulsion system for certain types of nutritional compositions, particularly hypoallergenic formulas that contain hydrolyzed protein, extensively hydrolyzed protein, or free amino acids. Specifically, many commonly used emulsifiers contain proteins that are allergenic in certain individuals.

Accordingly, there is a need for an emulsion system that provides effective emulsification of nutritional composition while avoiding the introduction of potentially allergenic levels of protein via the emulsifying agent. Additionally, an emulsion system should prevent creaming of both liquid and reconstituted powder nutritional compositions.

### BRIEF SUMMARY

The present disclosure provides in certain embodiments a nutritional composition comprising a protein equivalent source, which comprises a hydrolyzed protein, amino acids, or a mixture thereof; a fat source; a carbohydrate source; and an emulsifier system comprising a waxy starch. In alternative embodiments, the nutritional composition comprises a waxy starch and a second emulsifier, such as citric acid esters of mono- and di-glycerides. In yet another embodiment, the nutritional composition comprises a waxy starch and an octenyl succinic anhydride-modified starch, such as octenyl succinic anhydride-modified tapioca starch. Waxy starches useful in certain embodiments of the present nutritional composition include waxy potato starch, waxy tapioca starch and waxy rice starch. Furthermore, the waxy starches may be in native or pre-gelatinized form, and in some embodiments, a combination of native and pre-gelatinized waxy starch is used.

The protein equivalent source comprises, in certain embodiments, a hydrolyzed protein or free amino acids, or a combination of both. For example, in particular embodiments, the protein equivalent source comprises a partially hydrolyzed protein, while in other embodiments, the protein equivalent source comprises an extensively hydrolyzed protein, and in still a further embodiment, the protein equivalent source comprises free amino acids. As such, the present nutritional compositions are useful, in certain embodiments, for providing nutritional support to individuals with protein allergies.

It is to be understood that both the foregoing general description and the following detailed description present embodiments of the disclosure and are intended to provide an overview or framework for understanding the nature and character of the disclosure as it is claimed. The description serves to explain the principles and operations of the claimed subject matter. Other and further features and advantages of the present disclosure will be readily apparent to those skilled in the art upon a reading of the following disclosure.

### DETAILED DESCRIPTION

Reference now will be made in detail to the embodiments of the present disclosure, one or more examples of which are set forth herein below. Each example is provided by way of explanation of the nutritional composition of the present disclosure and is not a limitation. In fact, it will be apparent to those skilled in the art that various modifications and variations can be made to the teachings of the present disclosure without departing from the scope or spirit of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are apparent from the following detailed description. It is to be understood by one of ordinary skill in the art that the present discussion is a description of exemplary embodiments only and is not intended as limiting the broader aspects of the present disclosure.

“Nutritional composition” means a substance or formulation that satisfies at least a portion of a subject's nutrient requirements. The terms “nutritional(s)”, “nutritional formula (s)”, “enteral nutritional(s)”, and “nutritional supplement(s)” are used as non-limiting examples of nutritional composition(s) throughout the present disclosure. Moreover, “nutritional composition(s)” may refer to liquids, powders, gels, pastes, solids, concentrates, suspensions, or ready-to-use forms of enteral formulas, oral formulas, formulas for infants, formulas for pediatric subjects, formulas for children, growing-up milks and/or formulas for adults.

The term “enteral” means deliverable through or within the gastrointestinal, or digestive, tract. “Enteral administration” includes oral feeding, intragastric feeding, transpyloric administration, or any other administration into the digestive tract. “Administration” is broader than “enteral administration” and includes parenteral administration or any other route of administration by which a substance is taken into a subject's body.

“Pediatric subject” means a human less than 13 years of age, and includes both infants and children. In some embodiments, a pediatric subject refers to a human subject that is less than 8 years old. In other embodiments, a pediatric subject refers to a human subject between 1 and 6 years of age. In still further embodiments, a pediatric subject refers to a human subject between 6 and 12 years of age.

“Infant” means a human subject ranging in age from birth to not more than one year and includes infants from 0 to 12 months corrected age. The phrase “corrected age” means an infant's chronological age minus the amount of time that the infant was born premature. Therefore, the corrected age is the age of the infant if it had been carried to full term. The term infant includes full term infants, preterm infants, low birth weight infants (infants weighing less 2500 g at birth), very low birth weight infants (infants weighing less than 1500 g at birth), and extremely low-birth weight infants (infants weighting less than 1000 g at birth). “Preterm” means an infant born before the end of the 37th week of gestation, while “full term” means an infant born after the end of the 37th week of gestation.

“Child” means a subject ranging in age from about 12 months to about 13 years. In some embodiments, a child is a subject between the ages of 1 and 12 years old. In other embodiments, the terms “children” or “child” refer to subjects that are between about one and about six years old, or between about seven and about 12 years old. In other embodiments, the terms “children” or “child” refer to any range of ages between about 12 months and about 13 years.

“Children's nutritional product” refers to a composition that satisfies at least a portion of the nutrient requirements of a child. A growing-up milk is an example of a children's nutritional product.

The term “degree of hydrolysis” refers to the extent to which peptide bonds are broken by a hydrolysis method. The term “partially hydrolyzed” means having a degree of hydrolysis which is greater than 0% but less than 50%, or in other embodiments, between about 4% and about 10%. The term “extensively hydrolyzed” means having a degree of hydrolysis which is greater than or equal to 50%.

The term “protein-free” means containing no measurable amount of protein, as measured by standard protein detection methods such as sodium dodecyl (lauryl) sulfate-polyacrylamide gel electrophoresis (SDS-PAGE) or size exclusion chromatography. In some embodiments, the nutritional composition is substantially free of protein.

“Infant formula” means a composition that satisfies at least a portion of the nutrient requirements of an infant. In the United States, the content of an infant formula is dictated by the federal regulations set forth at 21 C.F.R. Sections 100, 106, and 107. These regulations define macronutrient, vitamin, mineral, and other ingredient levels in an effort to simulate the nutritional and other properties of human breast milk.

The term “growing-up milk” refers to a broad category of nutritional compositions intended to be used as a part of a diverse diet in order to support the normal growth and development of a child between the ages of about 1 and about 6 years of age.

“Nutritionally complete” means a composition that may be used as the sole source of nutrition, which would supply essentially all of the required daily amounts of vitamins, minerals, and/or trace elements in combination with proteins, carbohydrates, and lipids. Indeed, “nutritionally complete” describes a nutritional composition that provides adequate amounts of carbohydrates, lipids, essential fatty acids, proteins, essential amino acids, conditionally essential amino acids, vitamins, minerals and energy required to support normal growth and development of a subject.

Therefore, a nutritional composition that is “nutritionally complete” for a preterm infant will, by definition, provide qualitatively and quantitatively adequate amounts of carbohydrates, lipids, essential fatty acids, proteins, essential amino acids, conditionally essential amino acids, vitamins, minerals, and energy required for growth of the preterm infant.

A nutritional composition that is “nutritionally complete” for a full term infant will, by definition, provide qualitatively and quantitatively adequate amounts of all carbohydrates, lipids, essential fatty acids, proteins, essential amino acids, conditionally essential amino acids, vitamins, minerals, and energy required for growth of the full term infant.

A nutritional composition that is “nutritionally complete” for a child will, by definition, provide qualitatively and quantitatively adequate amounts of all carbohydrates, lipids, essential fatty acids, proteins, essential amino acids, conditionally essential amino acids, vitamins, minerals, and energy required for growth of a child.

As applied to nutrients, the term “essential” refers to any nutrient that cannot be synthesized by the body in amounts sufficient for normal growth and to maintain health and that, therefore, must be supplied by the diet. The term “conditionally essential” as applied to nutrients means that the nutrient must be supplied by the diet under conditions when adequate amounts of the precursor compound is unavailable to the body for endogenous synthesis to occur.

“Probiotic” means a microorganism with low or no pathogenicity that exerts a beneficial effect on the health of the host. The term “inactivated probiotic” or “inactivated LGG” means a probiotic wherein the metabolic activity or reproductive ability of the referenced probiotic or Lactobacillus rhamnosus GG (LGG) organism has been reduced or destroyed. In activated probiotics also include inactivated Bifidobacterium species. The “inactivated probiotic” or “inactivated LGG” does, however, still retain, at the cellular level, at least a portion its biological glycol-protein and DNA/RNA structure. As used herein, the term “inactivated” is synonymous with “non-viable”

“Prebiotic” means a non-digestible food ingredient that beneficially affects the host by selectively stimulating the growth and/or activity of one or a limited number of bacteria in the digestive tract that can improve the health of the host.

All percentages, parts and ratios as used herein are by weight of the total formulation, unless otherwise specified.

All amounts specified as administered “per day” may be delivered in one unit dose, in a single serving or in two or more doses or servings administered over the course of a 24 hour period.

The nutritional composition of the present disclosure may be substantially free of any optional or selected ingredients described herein, provided that the remaining nutritional composition still contains all of the required ingredients or features described herein. In this context, and unless otherwise specified, the term “substantially free” means that the selected composition may contain less than a functional amount of the optional ingredient, typically less than 0.1% by weight, and also, including zero percent by weight of such optional or selected ingredient.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

As used herein, the term “about” should be construed to refer to both of the numbers specified as the endpoint(s) of any range. Any reference to a range should be considered as providing support for any subset within that range.

The present disclosure provides emulsion systems that are useful in nutritional compositions. The emulsions system disclosed herein comprises a waxy starch, or a waxy starch and citric acid esters of mono- and di-glycerides (CITREM). In other embodiments, the emulsion system comprises a waxy starch and an octenyl succinic anhydride (OSA)-modified starch, such as OSA-modified tapioca starch. In certain embodiments, the waxy starch is waxy potato starch, waxy tapioca starch, or waxy rice starch, any of which may be provided in native form, pre-gelatinized form, or both native and pre-gelatinized forms. Waxy starches generally refer to starches containing 95% or more of amylopectin, which depend on cultivar and test methods. Pregelatinized starch (sometimes called pregels, instant starch, or cold-water-swellable and cold-water-soluble starch) is a starch product manufactured using processing techniques that gelatinize starch and then recover it as a dry powder. General pregelatinization methods include drum drying, spray drying, extrusion, and solvent-based processing.

The emulsion systems described herein are particularly useful in nutritional compositions such as infant formulas. However, the emulsion systems are also useful in nutritional compositions for children and adults. More particularly, the emulsions systems are useful in nutritional compositions designed for individuals with certain protein allergies, such as infants with cow's milk protein allergy (CMA) or multiple protein allergy. Such nutritional compositions typically comprise a protein equivalent source, such as hydrolyzed protein, free amino acids or both. For example, the protein equivalent source in such hypoallergenic nutritional compositions typically comprises hydrolyzed proteins and/or amino acids. However, the emulsion system is also useful in nutritional compositions comprising a whole protein source.

Accordingly, in certain embodiments, the present disclosure provides a nutritional composition comprising a protein source, a fat source, a carbohydrate source, and an emulsion system comprising a waxy starch. Waxy starches useful in the present compositions include, without limitation, waxy potato starch, waxy tapioca starch, waxy rice starch and combinations thereof. The emulsion system further comprises, in certain embodiments, citric acid esters of mono and/or diglycerides (CITREM). CITREM is an emulsifier that is commercially available, for example, from Danisco as Grindsted® CITREM. Other emulsifiers or combinations thereof include diacetyl tartaric acid esters of mono- and/or diglycerides (DATEM), octenyl succinic anhydride modified starches, lecithin, mono- and/or diglycerides.

The waxy starch may be in native or pre-gelatinized form, or the waxy starch may be a combination of native and pre-gelatinized starches. In embodiments comprising both native and pre-gelatinized starches, the weight ratio of native to pre-gelatinized waxy starch may range from about 0.1:1 to about 2:1. In other embodiments, the weight ratio of native to pre-gelatinized waxy starch may range from about 0.5:1 to about 2:1, about 0.5:1 to about 1:1, or about 1:1 to about 2:1. Any combination of pre-gelatinized and native waxy starches, such as potato, rice, or tapioca, may be used in the nutritional compositions of the present disclosure. In a particular embodiment, the starch is a native waxy potato starch and a pre-gelatinized waxy potato starch in a ratio of about 0.5:1 to about 1:1.

Certain waxy starches contain only trace amounts of protein, and therefore may be particularly suitable for use in nutritional products for allergic individuals. In certain embodiments, the total protein content of the waxy starch is less than about 0.10% by weight. In other embodiments, the total protein content of the waxy starch is about 0 to about 0.10% by weight, or about 0 about 0.01% by weight. A non-limiting example of a commercially available waxy potato starch useful in the present compositions includes Elian 100, available from AVEBE (Netherlands). Elian 100 is a non-GMO native waxy potato starch containing more than 95% of amylopectin. Another example of a waxy starch useful in the present compositions is a waxy tapioca starch that has recently been discovered in Columbia. Table 1 lists the nitrogen and protein content in several commercial octenyl succinic anhydride (OSA)-modified starches and waxy potato starches.

TABLE 1
Total nitrogen and protein content of various starch samples.

| | Total Nitrogen | Total Protein |
|---|---|---|
| Starch | (w/w %) | (N × 6.25, %) |
| OSA-Corn starch (Batch A) | 0.019 | 0.119 |
| OSA-corn starch (Batch B) | 0.025 | 0.156 |
| OSA-Tapioca starch (Batch A) | 0.003 | 0.019 |
| Native waxy potato starch Eliane 100 | 0.001 | 0.006 |
| (Batch A) | | |
| Native waxy potato starch Eliane 100 | 0.001 | 0.006 |
| (Batch B) | | |
| Pre-gelatinized waxy potato starch | 0.006 | 0.038 |
| Eliane EZ 100 (Batch A) | | |

The emulsion system described herein also may provide increased viscosity in the final nutritional composition, which may improve feeding tolerance compared to other powdered nutritional compositions. Furthermore, the total amount of starch used in the present nutritional compositions can be advantageously adjusted based on desired viscosity and processing conditions. The total amount of starch also contributes to desirable anti-regurgitation properties of the nutritional compositions. For example, post-prandial gastro-esophageal reflux (regurgitation or spitting up) is common in newborns and infants, and often subsides after about 6 months of age. While not being bound by theory, it is believed that the inclusion of the waxy starches described herein may thicken infant formula such that regurgitation is reduced or prevented. In some embodiments, the total amount of starch used in the present nutritional compositions is less than 18% by weight. In other embodiments, the total amount of starch is between about 3% and 18%, about 5% and 18%, or about 10% and 18%. In a particular embodiment, the total amount of starch is between about 10 and about 17%.

The amount of CITREM used in the present nutritional compositions may be up to about 5% by weight of the nutritional composition. In particular embodiments, the amount of CITREM ranges from about 0.1 to about 2% by weight, about 0.1 to about 1% by weight, or about 0.2 to about 0.7% by weight.

The nutritional compositions may include any protein source commonly used in the art. However, the emulsifier system disclosed herein is particularly suitable for use in hypoallergenic formulas, such as those containing protein equivalent sources. Protein equivalent sources useful in the present compositions include hydrolyzed proteins, amino acids, or combinations thereof. Accordingly, in some embodiments, the protein equivalent source comprises hydrolyzed proteins, free amino acids, or mixtures thereof. In still other embodiments, the protein equivalent source comprises free amino acids.

In more particular embodiments, the protein equivalent source comprises a hydrolyzed plant protein, or a hydrolyzed bovine milk protein, such as casein or whey protein, free amino acids, and combinations thereof. Hydrolyzed plant proteins useful in the present nutritional compositions include and partially and/or extensively hydrolyzed plant protein, such as pea protein, soy protein, rice protein, amaranth protein, quinoa protein, algae protein, potato protein, wheat protein, corn protein, or a combination thereof. For example, the protein equivalent source comprises, in some embodiments, a partially hydrolyzed rice protein, an extensively hydrolyzed casein protein, free amino acids, or a combination thereof.

In some embodiments, the nutritional composition comprises between about 1 g and about 7 g of the protein source or protein equivalent source per 100 kcal.

Suitable fat or lipid sources for the nutritional composition of the present disclosure may be any known or used in the art, including but not limited to, animal sources, e.g., milk fat, butter, butter fat, egg yolk lipid; marine sources, such as fish oils, marine oils, single cell oils; vegetable and plant oils, such as corn oil, canola oil, sunflower oil, soybean oil, palm olein oil, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof.

Carbohydrate sources can be any used in the art, e.g., lactose, glucose, fructose, corn syrup solids, maltodextrins, sucrose, starch, rice syrup solids, and the like. The amount of carbohydrate in the nutritional composition typically can vary from between about 5 g and about 25 g/100 kcal.

In one embodiment, the nutritional composition further comprises one or more probiotics. Any probiotic known in the art may be acceptable in this embodiment. In a particular embodiment, the probiotic may be selected from any Lactobacillus species, Lactobacillus rhamnosus GG (e.g., ATCC number 53103), Bifidobacterium species, Bifidobacterium longum (e.g. AH1205 or AH1206), and Bifidobacterium animalis subsp. lactis BB-12 (DSM No. 10140), Bifidobacterium infantis (e.g. 35624), or any combination thereof.

If included in the composition, the amount of the probiotic may vary from about 1×10⁴ to about 1×10¹² colony forming units (cfu) per gram of the nutritional composition. In another embodiment, the amount of the probiotic may vary from about 1×10⁶ to about 1×10¹² cfu per gram of the nutritional composition. In still another embodiment, the amount of the probiotic may vary from about 1×10⁶ to about 1×10⁹ cfu per gram of the nutritional composition, or about 1×10⁹ to about 1×10¹² cfu per gram of the nutritional composition. In yet another embodiment, the amount of the probiotic may be at least about 1×10⁶ cfu per gram of the nutritional composition.

In an embodiment, the probiotic(s) may be viable or non-viable. As used herein, the term “viable”, refers to live microorganisms. The term “non-viable” or “non-viable probiotic” means non-living probiotic microorganisms, their cellular components and/or metabolites thereof. Such non-viable probiotics may have been heat-killed or otherwise inactivated, but they retain the ability to favorably influence the health of the host. The probiotics useful in the present disclosure may be naturally-occurring, synthetic or developed through the genetic manipulation of organisms, whether such new source is now known or later developed.

The nutritional composition may also contain one or more prebiotics in certain embodiments. Such prebiotics may be naturally-occurring, synthetic, or developed through the genetic manipulation of organisms and/or plants, whether such new source is now known or developed later. Prebiotics useful in the present disclosure may include oligosaccharides, polysaccharides, and other prebiotics that contain fructose, xylose, soya, galactose, glucose and mannose.

More specifically, prebiotics useful in the present disclosure may include polydextrose, polydextrose powder, lactulose, lactosucrose, raffinose, gluco-oligosaccharide, inulin, fructo-oligosaccharide, isomalto-oligosaccharide, soybean oligosaccharides, lactosucrose, xylo-oligosaccharide, chito-oligosaccharide, manno-oligosaccharide, aribino-oligosaccharide, siallyl-oligosaccharide, fuco-oligosaccharide, galacto-oligosaccharide, and gentio-oligosaccharides.

In an embodiment, the total amount of prebiotics present in the nutritional composition may be from about 1.0 g/L to about 10.0 g/L of the composition. At least 20% of the prebiotics can comprise galacto-oligosaccharide (GOS), polydextrose (PDX) or a mixture thereof. The amount of each of GOS and/or PDX in the nutritional composition may, in an embodiment, be within the range of from about 1.0 g/L to about 4.0 g/L.

In an embodiment, the total amount of prebiotics present in the nutritional composition may be from about 1.0 g/L to about 10.0 g/L of the composition. For example, in some embodiments, PDX may be included in the nutritional composition in an about of about 1.0 to 10.g/L. In another embodiment, the amount of PDX is about 2.0 to about 8.0 g/L.

In certain embodiments, at least 20% of the prebiotics can comprise a mixture of GOS and PDX. In an embodiment, the PDX and GOS have a PDX:GOS ratio of between about 9:1 and 1:9. In another embodiment, the ratio of PDX:GOS can be about 5:1 to 1:5. In yet another embodiment, the ratio of PDX:GOS can be between about 1:3 and 1:3. In further more particular embodiments, the ratio can be about 1:1 or 4:1. In another embodiment, the amount of the PDX:GOS combination may be between about 2.0 g/L and 8.0 g/L. In a particular embodiment, the amount of the PDX:GOS combination may be about 2 g/L of PDX and 2 g/L of GOS. At least 20% of the prebiotics can comprise GOS and PDX, or a mixture thereof. The amount of each of GOS and/or PDX in the nutritional composition may, in an embodiment, be within the range of from about 1.0 g/L to about 4.0 g/L.

The nutritional composition of the disclosure may contain a source of long chain polyunsaturated fatty acid (LCPUFA) that comprises docosahexaenoic acid (DHA). Other suitable LCPUFAs include, but are not limited to, α-linoleic acid, γ-linoleic acid, linoleic acid, linolenic acid, eicosapentaenoic acid (EPA) and arachidonic acid (ARA).

In an embodiment, especially if the nutritional composition is an infant formula, the nutritional composition is supplemented with both DHA and ARA. In this embodiment, the weight ratio of ARA:DHA may be between about 1:3 and about 9:1. In a particular embodiment, the ratio of ARA:DHA is from about 1:2 to about 4:1.

The amount of long chain polyunsaturated fatty acids in the nutritional composition is advantageously at least about 5 mg/100 Kcal, and may vary from about 5 mg/100 kcal to about 100 mg/100 kcal, more preferably from about 10 mg/100 kcal to about 50 mg/100 kcal.

The nutritional composition may be supplemented with oils containing DHA and/or ARA using standard techniques known in the art. For example, DHA and ARA may be added to the composition by replacing an equivalent amount of an oil, such as high oleic sunflower oil, normally present in the composition. As another example, the oils containing DHA and ARA may be added to the composition by replacing an equivalent amount of the rest of the overall fat blend normally present in the composition without DHA and ARA.

If included, the source of DHA and/or ARA may be any source known in the art such as marine oil, fish oil, single cell oil, egg yolk lipid, and brain lipid. In some embodiments, the DHA and ARA are sourced from single cell Martek oils, DHAS CO® and ARAS CO®, or variations thereof. The DHA and ARA can be in natural form, provided that the remainder of the LCPUFA source does not result in any substantial deleterious effect on the subject. Alternatively, the DHA and ARA can be used in refined form.

In an embodiment, sources of DHA and ARA are single cell oils as taught in U.S. Pat. Nos. 5,374,657; 5,550,156; and 5,397,591, the disclosures of which are incorporated herein in their entirety by reference. Nevertheless, the present disclosure is not limited to only such oils.

The nutritional composition may also comprise a source of β-glucan. Glucans are polysaccharides, specifically polymers of glucose, which are naturally occurring and may be found in cell walls of bacteria, yeast, fungi, and plants. Beta glucans (β-glucans) are themselves a diverse subset of glucose polymers, which are made up of chains of glucose monomers linked together via beta-type glycosidic bonds to form complex carbohydrates.

β-1,3-glucans are carbohydrate polymers purified from, for example, yeast, mushroom, bacteria, algae, or cereals. (Stone B A, Clarke A E. Chemistry and Biology of (1-3)-Beta-Glucans. London:Portland Press Ltd; 1993.) The chemical structure of β-1,3-glucan depends on the source of the β-1,3-glucan. Moreover, various physiochemical parameters, such as solubility, primary structure, molecular weight, and branching, play a role in biological activities of β-1,3-glucans. (Yadomae T., Structure and biological activities of fungal beta-1,3-glucans. Yakugaku Zasshi. 2000; 120:413-431.)

β-1,3-glucans are naturally occurring polysaccharides, with or without β-1,6-glucose side chains that are found in the cell walls of a variety of plants, yeasts, fungi and bacteria. β-1,3;1,6-glucans are those containing glucose units with (1,3) links having side chains attached at the (1,6) position(s). β-1,3;1,6 glucans are a heterogeneous group of glucose polymers that share structural commonalities, including a backbone of straight chain glucose units linked by a β-1,3 bond with β-1,6-linked glucose branches extending from this backbone. While this is the basic structure for the presently described class of β-glucans, some variations may exist.

For example, certain yeast β-glucans have additional regions of β(1,3) branching extending from the β(1,6) branches, which add further complexity to their respective structures.

β-glucans derived from baker's yeast, Saccharomyces cerevisiae, are made up of chains of D-glucose molecules connected at the 1 and 3 positions, having side chains of glucose attached at the 1 and 6 positions. Yeast-derived β-glucan is an insoluble, fiber-like, complex sugar having the general structure of a linear chain of glucose units with a β-1,3 backbone interspersed with β-1,6 side chains that are generally 6-8 glucose units in length. More specifically, β-glucan derived from baker's yeast is poly-(1,6)-β-D-glucopyranosyl-(1,3)-β-D-glucopyranose.

Furthermore, β-glucans are well tolerated and do not produce or cause excess gas, abdominal distension, bloating or diarrhea in pediatric subjects. Addition of β-glucan to a nutritional composition for a pediatric subject, such as an infant formula, a growing-up milk or another children's nutritional product, will improve the subject's immune response by increasing resistance against invading pathogens and therefore maintaining or improving overall health.

The nutritional composition(s) of the present disclosure may further comprises, in certain embodiments, nucleotides, including without limitation, cytidine 5′-monophosphate, uridine 5′monophosphate, adenosine 5′-monophosphate, guanosine 5′monophosphate, and mixtures thereof.

In an embodiment, the nutritional composition(s) of the present disclosure comprises choline. Choline is a nutrient that is essential for normal function of cells. It is a precursor for membrane phospholipids, and it accelerates the synthesis and release of acetylcholine, a neurotransmitter involved in memory storage. Moreover, though not wishing to be bound by this or any other theory, it is believed that dietary choline and docosahexaenoic acid (DHA) act synergistically to promote the biosynthesis of phosphatidylcholine and thus help promote synaptogenesis in human subjects. Additionally, choline and DHA may exhibit the synergistic effect of promoting dendritic spine formation, which is important in the maintenance of established synaptic connections. In some embodiments, the nutritional composition(s) of the present disclosure includes about 40 mg choline per serving to about 100 mg per 8 oz. serving.

In an embodiment, the nutritional composition comprises a source of iron. In an embodiment, the source of iron is ferric pyrophosphate, ferric orthophosphate, ferrous fumarate or a mixture thereof and the source of iron may be encapsulated in some embodiments.

One or more vitamins and/or minerals may also be added in to the nutritional composition in amounts sufficient to supply the daily nutritional requirements of a subject. It is to be understood by one of ordinary skill in the art that vitamin and mineral requirements will vary, for example, based on the age of the child. For instance, an infant may have different vitamin and mineral requirements than a child between the ages of one and thirteen years. Thus, the embodiments are not intended to limit the nutritional composition to a particular age group but, rather, to provide a range of acceptable vitamin and mineral components.

In certain embodiments, the composition may optionally include one or more of the following vitamins or derivations thereof: vitamin B₁ (thiamin, thiamin pyrophosphate, TPP, thiamin triphosphate, TTP, thiamin hydrochloride, thiamin mononitrate), vitamin B₂ (riboflavin, flavin mononucleotide, FMN, flavin adenine dinucleotide, FAD, lactoflavin, ovoflavin), vitamin B₃ (niacin, nicotinic acid, nicotinamide, niacinamide, nicotinamide adenine dinucleotide, NAD, nicotinic acid mononucleotide, NicMN, pyridine-3-carboxylic acid), vitamin B₃-precursor tryptophan, vitamin B₆ (pyridoxine, pyridoxal, pyridoxamine, pyridoxine hydrochloride), pantothenic acid (pantothenate, panthenol), folate (folic acid, folacin, pteroylglutamic acid), vitamin B₁₂ (cobalamin, methylcobalamin, deoxyadenosylcobalamin, cyanocobalamin, hydroxycobalamin, adenosylcobalamin), biotin, vitamin C (ascorbic acid), vitamin A (retinol, retinyl acetate, retinyl palmitate, retinyl esters with other long-chain fatty acids, retinal, retinoic acid, retinol esters), vitamin D (calciferol, cholecalciferol, vitamin D₃, 1,25,-dihydroxyvitamin D), vitamin E (α-tocopherol, α-tocopherol acetate, α-tocopherol succinate, α-tocopherol nicotinate, α-tocopherol), vitamin K (vitamin K₁, phylloquinone, naphthoquinone, vitamin K₂, menaquinone-7, vitamin K₃, menaquinone-4, menadione, menaquinone-8, menaquinone-8H, menaquinone-9, menaquinone-9H, menaquinone-10, menaquinone-11, menaquinone-12, menaquinone-13), choline, inositol, β-carotene and any combinations thereof.

In other embodiments, the composition may optionally include, but is not limited to, one or more of the following minerals or derivations thereof: boron, calcium, calcium acetate, calcium gluconate, calcium chloride, calcium lactate, calcium phosphate, calcium sulfate, chloride, chromium, chromium chloride, chromium picolonate, copper, copper sulfate, copper gluconate, cupric sulfate, fluoride, iron, carbonyl iron, ferric iron, ferrous fumarate, ferric orthophosphate, iron trituration, polysaccharide iron, iodide, iodine, magnesium, magnesium carbonate, magnesium hydroxide, magnesium oxide, magnesium stearate, magnesium sulfate, manganese, molybdenum, phosphorus, potassium, potassium phosphate, potassium iodide, potassium chloride, potassium acetate, selenium, sulfur, sodium, docusate sodium, sodium chloride, sodium selenate, sodium molybdate, zinc, zinc oxide, zinc sulfate and mixtures thereof. Non-limiting exemplary derivatives of mineral compounds include salts, alkaline salts, esters and chelates of any mineral compound. However, in particular embodiments, the compositions do not include manganese gluconate, copper carbonate or zinc oxide.

The minerals can be added to growing-up milks or to other children's nutritional compositions in the form of salts such as calcium phosphate, calcium glycerol phosphate, sodium citrate, potassium chloride, potassium phosphate, magnesium phosphate, ferrous sulfate, zinc sulfate, cupric sulfate, manganese sulfate, and sodium selenite. Additional vitamins and minerals can be added as known within the art.

The amounts of vitamins and minerals in the children's nutritional composition may vary on a country by country basis. In an embodiment, the children's nutritional composition may contain between about 10 and about 50% of the maximum dietary recommendation for any given country, or between about 10 and about 50% of the average dietary recommendation for a group of countries, per serving of vitamins A, C, and E, zinc, iron, iodine, selenium, and choline. In another embodiment, the children's nutritional composition may supply about 10-30% of the maximum dietary recommendation for any given country, or about 10-30% of the average dietary recommendation for a group of countries, per serving of B-vitamins. In yet another embodiment, the levels of vitamin D, calcium, magnesium, phosphorus, and potassium in the children's nutritional product may correspond with the average levels found in milk. In other embodiments, other nutrients in the children's nutritional composition may be present at about 20% of the maximum dietary recommendation for any given country, or about 20% of the average dietary recommendation for a group of countries, per serving.

The children's nutritional composition of the present disclosure may optionally include one or more of the following flavoring agents, including, but not limited to, flavored extracts, volatile oils, cocoa or chocolate flavorings, peanut butter flavoring, cookie crumbs, vanilla or any commercially available flavoring. Examples of useful flavorings include, but are not limited to, pure anise extract, imitation banana extract, imitation cherry extract, chocolate extract, pure lemon extract, pure orange extract, pure peppermint extract, honey, imitation pineapple extract, imitation rum extract, imitation strawberry extract, or vanilla extract; or volatile oils, such as balm oil, bay oil, bergamot oil, cedarwood oil, cherry oil, cinnamon oil, clove oil, or peppermint oil; peanut butter, chocolate flavoring, vanilla cookie crumb, butterscotch, toffee, and mixtures thereof. The amounts of flavoring agent can vary greatly depending upon the flavoring agent used. The type and amount of flavoring agent can be selected as is known in the art.

The nutritional compositions of the present disclosure may optionally include one or more preservatives that may also be added to extend product shelf life. Suitable preservatives include, but are not limited to, potassium sorbate, sodium sorbate, potassium benzoate, sodium benzoate, calcium disodium EDTA, and mixtures thereof.

The nutritional compositions of the present disclosure may optionally include one or more stabilizers. Suitable stabilizers for use in practicing the nutritional composition of the present disclosure include, but are not limited to, gum arabic, gum ghatti, gum karaya, gum tragacanth, agar, furcellaran, guar gum, gellan gum, locust bean gum, pectin, low methoxyl pectin, gelatin, microcrystalline cellulose, CMC (sodium carboxymethylcellulose), methylcellulose hydroxypropyl methyl cellulose, hydroxypropyl cellulose, DATEM (diacetyl tartaric acid esters of mono- and diglycerides), dextran, carrageenans, and mixtures thereof.

The nutritional compositions of the disclosure may provide minimal, partial or total nutritional support. The compositions may be nutritional supplements or meal replacements. The compositions may, but need not, be nutritionally complete. In an embodiment, the nutritional composition of the disclosure is nutritionally complete and contains suitable types and amounts of lipid, carbohydrate, protein, vitamins and minerals. The amount of lipid or fat typically can vary from about 2 to about 7 g/100 kcal. The amount of protein typically can vary from about 1 to about 5 g/100 kcal. The amount of carbohydrate typically can vary from about 8 to about 14 g/100 kcal.

The nutritional composition may be a powdered formula, which is reconstituted by mixing with a liquid such as water, or a ready to use liquid formula, or a liquid concentrate.

In some embodiments, the nutritional composition of the present disclosure is a growing-up milk. Growing-up milks are fortified milk-based beverages intended for children over 1 year of age (typically from 1-6 years of age). They are not medical foods and are not intended as a meal replacement or a supplement to address a particular nutritional deficiency. Instead, growing-up milks are designed with the intent to serve as a complement to a diverse diet to provide additional insurance that a child achieves continual, daily intake of all essential vitamins and minerals, macronutrients plus additional functional dietary components, such as non-essential nutrients that have purported health-promoting properties.

The exact composition of an infant formula or a growing-up milk or other nutritional composition according to the present disclosure can vary from country to country, depending on local regulations and dietary intake information of the population of interest. In some embodiments, nutritional compositions according to the disclosure consist of a milk protein or protein equivalent source, such as whole or skim milk, plus added sugar and sweeteners to achieve desired sensory properties, and added vitamins and minerals. The fat composition is typically derived from the milk raw materials. Total protein can be targeted to match that of human milk, cow milk or a lower value. Total carbohydrate is usually targeted to provide as little added sugar, such as sucrose or fructose, as possible to achieve an acceptable taste. Typically, Vitamin A, calcium and Vitamin D are added at levels that depend on the nutrient contribution of regional cow's milk. Otherwise, in some embodiments, vitamins and minerals can be added at levels that provide approximately 20% of the dietary reference intake (DRI) or 20% of the Daily Value (DV) per serving. Moreover, nutrient values can vary between markets depending on the identified nutritional needs of the intended population, raw material contributions and regional regulations.

The present disclosure also provides methods for preparing the above-described nutritional compositions. For example, in certain embodiments, CITREM can be combined, such as by blending, with a fat source and then transferred to container comprising a slurry of other ingredients, including a native waxy starch. After mixing, the slurry may be processed, such as by direct steam injection (DSI) and homogenization prior to spray drying to provide a powder. The spray-dried powder can be dry blended with a pre-gelatinized starch to provide the final product.

Examples are provided to illustrate some embodiments of the nutritional composition of the present disclosure but should not be interpreted as any limitation thereon. Other embodiments within the scope of the claims herein will be apparent to one skilled in the art from the consideration of the specification or practice of the nutritional composition or methods disclosed herein. It is intended that the specification, together with the examples, be considered to be exemplary only, with the scope and spirit of the disclosure being indicated by the claims which follow the examples.

### EXAMPLES

### Example 1

Example 1 is an amino acid formula with pregelatinized waxy potato starch and OSA-modified tapioca starch (Table 2). There is no creaming observed, in contrast to similar formulations that do not include the waxy potato starch.

TABLE 2
Amino acid based formula with pre-gelatinized potato
starch and OSA-modified tapioca starch.

| Ingredient | Amount per 100 g | Unit |
|---|---|---|
| Corn syrup solids | 40.56 | g |
| Fat blend | 25.1 | g |
| ARA and DHA | 0.7 | g |
| OSA-modified tapioca starch | 3 | g |
| Calcium phosphate | 1.6 | g |
| Calcium citrate | 0.4 | g |
| Calcium hydroxide | 0.15 | g |
| Choline chloride | 0.18 | g |
| Potassium chloride | 0.2 | g |
| Potassium citrate | 1.3 | g |
| Sodium citrate | 0.3 | g |
| Magnesium oxide | 0.1 | g |
| L-carnitine | 0.01 | g |
| Sodium iodide | 0.1 | mg |
| Amino acid mix | 19.6 | g |
| Vitamin mix | 0.4 | g |
| Trace/ultratrace minerals | 0.2 | g |
| Iron trituration | 0.2 | g |
| Pregelatinized waxy potato starch | 6 | g |

### Example 2

Example 2 is an amino acid formula with waxy potato starch and CITREM (Table 3).

TABLE 3
An amino acid based formula with both native and
pre-gelatinized starch.

| Ingredient | Amount per 100 g | Unit |
|---|---|---|
| Corn syrup solids | 36.56 | g |
| Fat blend | 25.1 | g |
| ARA and DHA | 0.7 | g |
| Calcium phosphate | 1.6 | g |
| Calcium citrate | 0.4 | g |
| Calcium hydroxide | 0.15 | g |
| Choline chloride | 0.18 | g |
| Potassium chloride | 0.2 | g |
| Potassium citrate | 1.3 | g |
| Sodium citrate | 0.3 | g |
| Magnesium oxide | 0.1 | g |
| L-carnitine | 0.01 | g |
| Sodium iodide | 0.1 | mg |
| CITREM | 0.5 | g |
| Waxy potato starch | 5 | g |
| Amino acid mix | 19.6 | g |
| Vitamin mix | 0.4 | g |
| Trace/ultratrace minerals | 0.2 | g |
| Iron trituration | 0.2 | g |
| Pregelatinized waxy potato starch | 7.5 | g |
| Corn syrup solids | 36.56 | g |

### Example 3

Example 3 is an extensively hydrolyzed protein based formula with waxy potato starch and CITREM (Table 4).

TABLE 4
An extensively hydrolyzed protein based formula with
both native and pre-gelatinized starch.

| Ingredient | Amount per 100 g | Unit |
|---|---|---|
| Corn syrup solids | 37 | g |
| Fat blend | 25 | g |
| ARA and DHA | 0.7 | g |
| Protein hydrolysate | 17 | g |
| Waxy potato starch | 7 | g |
| Calcium citrate | 1.1 | g |
| Calcium phosphate | 0.8 | g |
| Potassium citrate | 0.6 | g |
| Potassium chloride | 0.4 | g |
| Choline chloride | 0.18 | g |
| Calcium hydroxide | 0.2 | g |
| Sodium citrate | 0.1 | g |
| Magnesium oxide | 0.1 | g |
| L-carnitine | 0.02 | g |
| Sodium iodide | 0.1 | mg |
| CITREM | 0.5 | g |
| Vitamin mix | 0.4 | g |
| Amino acid mix | 0.3 | g |
| Trace/ultratrace minerals | 0.2 | g |
| Iron trituration | 0.2 | g |
| Lactobacillus | 0.2 | g |
| Pregelatinized waxy potato starch | 8 | g |

### Example 4

Example 4 is a partially hydrolyzed plant protein based formula with waxy rice starch and CITREM (Table 5).

TABLE 5
A partially hydrolyzed rice protein based formula

| Ingredient | Amount per 100 g | Unit |
|---|---|---|
| Maltodextrin | 43.84 | g |
| Fat blend | 25.4 | g |
| Protein hydrolysate | 17 | g |
| Waxy rice starch | 7.4 | g |
| Calcium phosphate | 1.3 | g |
| Calcium citrate | 0.9 | g |
| Potassium citrate | 0.8 | g |
| ARA and DHA | 0.7 | g |
| CITREM | 0.5 | g |
| Sodium citrate | 0.2 | g |
| Choline chloride | 0.2 | g |
| Potassium chloride | 0.1 | g |
| Magnesium oxide | 0.07 | g |
| Calcium hydroxide | 0.06 | g |
| L-carnitine | 0.01 | g |
| Sodium iodide | 0.1 | mg |
| Amino acid mix | 0.9 | g |
| Vitamin-taurine mix | 0.3 | g |
| Iron trituration | 0.2 | g |
| Trace/ultratrace minerals | 0.12 | g |

### Example 5

Example 5 is a plant protein hydrolysate based formula with waxy potato starch and CITREM (Table 6).

TABLE 6
A partially hydrolyzed rice protein based formula.

| Ingredient | Amount per 100 g | Unit |
|---|---|---|
| Maltodextrin | 36.34 | g |
| Fat blend | 25.4 | g |
| Plant protein hydrolysate | 17 | g |
| Waxy potato starch | 7.4 | g |
| Calcium phosphate | 1.3 | g |
| Calcium citrate | 0.9 | g |
| Potassium citrate | 0.8 | g |
| ARA and DHA | 0.7 | g |
| CITREM | 0.5 | g |
| Sodium citrate | 0.2 | g |
| Choline chloride | 0.2 | g |
| Potassium chloride | 0.1 | g |
| Magnesium oxide | 0.07 | g |
| Calcium hydroxide | 0.06 | g |
| L-carnitine | 0.01 | g |
| Sodium iodide | 0.1 | mg |
| Amino acid mix | 0.9 | g |
| Vitamin-taurine mix | 0.3 | g |
| Iron trituration | 0.2 | g |
| Pregelatinized waxy potato starch | 7.5 | g |
| Trace/ultratrace minerals | 0.12 | g |

Native and pre-gelatinized potato starch used in these formulas could be replaced by native and pre-gelatinized tapioca and/or rice starch. Similarly, the rice starch used in example 4 could be replaced by potato and/or tapioca starch.

The combination of CITREM and one or two starches, such as waxy potato starch, waxy tapioca starch and waxy rice starch, can be used in liquid infant formula as well, particularly for hypoallergenic formulas, such as extensively hydrolyzed cow's milk protein based formulas, amino acid based formulas, and partially and/or extensively hydrolyzed plant protein based formulas. These plant proteins could include pea protein, soy protein, rice protein, amaranth protein quinoa protein, algae protein, potato protein, wheat protein, corn protein, or a combination thereof.

What is claimed is:

1. A nutritional composition comprising:
a protein equivalent source comprising a hydrolyzed protein, amino acids, or a mixture thereof,
a fat source,
a carbohydrate source, and
and an emulsifier system comprising a waxy starch.

2. The nutritional composition of claim 1, wherein the waxy starch comprises waxy potato starch, waxy tapioca starch, waxy rice starch, or combinations thereof.

3. The nutritional composition of claim 1, wherein the waxy starch comprises a native waxy starch, a pre-gelatinized waxy starch, or a combination thereof.

4. The nutritional composition of claim 1, further comprising citric acid esters of mono- and di-glycerides.

5. The nutritional composition of claim 4, wherein the amount of the citric acid esters of mono- and di-glycerides is about 0.1 to about 1% by weight of the composition.

6. The nutritional composition of claim 1, wherein the total amount of starch in the composition is less than 18% by weight of the composition.

7. The nutritional composition of claim 1, wherein the total protein content of the waxy starch is less than about 0.10% by weight of the waxy starch.

8. The nutritional composition of claim 1, wherein the protein equivalent source comprises casein protein hydrolysate, soy protein hydrolysate, pea protein hydrolysate, amaranth protein hydrolysate, quinoa protein hydrolysate, algae protein hydrolysate, rice protein hydrolysate, potato protein hydrolysate, wheat protein hydrolysate, corn protein hydrolysate, whey protein hydrolysate, free amino acids, or a combination thereof.

9. The nutritional composition of claim 1, wherein in the protein equivalent source comprises extensively hydrolyzed casein protein or a combination of extensively hydrolyzed casein protein and free amino acids.

10. The nutritional composition of claim 1, wherein the protein equivalent source comprises hydrolyzed rice protein or a combination of hydrolyzed rice protein and free amino acids.

11. The nutritional composition of claim 1, wherein the protein equivalent source comprises free amino acids.

12. The nutritional composition of claim 1, further comprising an octenyl succinic anhydride-modified starch.

13. The nutritional composition of claim 12, wherein the octenyl succinic anhydride-modified starch is octenyl succinic anhydride-modified waxy tapioca starch.

14. The nutritional composition of claim 1, further comprising a source of docosahexaenoic acid and arachidonic acid.

15. The nutritional composition of claim 1, further comprising a prebiotic.

16. The composition of claim 15, wherein the prebiotic comprises polydextrose and galacto-oligosaccharide.

17. The nutritional composition of claim 1, further comprising one or more probiotics.

18. The nutritional composition of claim 1, wherein the nutritional composition is an infant formula.

19. The nutritional composition of claim 1, wherein the composition is a powdered nutritional composition.

20. The nutritional composition of claim 1, wherein the nutritional composition is a liquid nutritional composition.
